(19) United States
(12) Patent Application Publication
(10) Pub. No.: US 2021/0046486 A1
(43) Pub. Date: Feb. 18, 2021

(54) AUTOMATIC SAFETY WOODCHIPPER

(71) Applicant: RJ RUNYON, Omaha, AR (US)

(72) Inventor: RJ RUNYON, Omaha, AR (US)

(21) Appl. No.: 16/995,417

(22) Filed: Aug. 17, 2020

Related U.S. Application Data
(60) Provisional application No. 62/887,035, filed on Aug. 15, 2019.

(51) Int. Cl. B02C 23/04; B02C 18/24; B02C 25/00

(52) U.S. Cl. CPC B02C 23/04; B02C 2201/066; B02C 25/00; B02C 18/24

(57) ABSTRACT

An automatic shutoff woodchipper having a blade for shredding material fed into the woodchipper, a motor to drive the blade, and a feed chute to direct material to the blade for shredding. An electronic sensor in the mouth of the feed chute sends an electronic proximity signal to an electronic controller when a signal device worn by an operator, detectable by the sensor, closes to within a predetermined distance from the sensor. Upon receiving the electronic proximity signal from the electronic sensor, the electronic controller generates an electronic shutoff signal that automatically halts the operation of the blade.

### CROSS REFERENCE TO RELATED APPLICATIONS

This application claims the benefit of U.S. Provisional Patent Application Ser. No. 62/887,035, filed Aug. 15, 2019 which is hereby incorporated herein by reference.

### STATEMENT REGARDING FEDERALLY SPONSORED RESEARCH OR DEVELOPMENT

Not applicable.

### BACKGROUND OF THE INVENTION

This invention relates generally to woodchippers, and woodchippers that provide safety mechanisms to help prevent accidental injuries to persons using the woodchipper. More particularly, this invention relates to a woodchipper that automatically shuts down when a user's hand or other extremity passes into proximity to the woodchipper mouth through which wood is inserted into the woodchipper for shredding by the blades of the woodchipper.

In the wood chipping industry, as in most industries, quantity and speed have in large part dictated equipment design. Consequently, commercial and industrial woodchippers are designed to chop and shred very large branches and limbs, as well as large bundles of branches, limbs and leaves, both quickly and without jamming the woodchipper. Such commercial and industrial woodchippers can be quite large and very powerful, utilizing multiple-horsepower engines or motors that drive large and very sharp rotational metal chipping/shredding blades at thousands of rotations per minute. In addition, such woodchippers are constructed with large mouths that neck down to large throats that provide direct access to the woodchipper blades. These woodchipper throats can be more than a foot high and a foot wide, which can easily allow a human limb to pass through. Larger woodchipper throats can even allow an entire human body to pass through.

While this design feature of commercial or industrial woodchippers is necessary for the operation of the woodchipper, it presents an extreme safety hazard for persons using the woodchipper. Dangerous and even deadly accidents can easily occur due to this hazard. For example, it is not uncommon for commercial or industrial woodchipper operators to attempt to force clumped or clogged limbs or brush through the woodchipper mouth, thereby exposing the operators to accidentally slip into the woodchipper mouth. It is also possible for branches or limbs carried by the operator and thrown into the mouth to catch or snag the operator's clothing and pull the operator into the mouth along with the wood. Such accidents are even more likely to occur when the operator is fatigued or distracted, or when the weather conditions are poor.

Most large woodchippers incorporate one or more various safety devices to help prevent such accidents. However, none of these traditional safety devices will automatically shut-down the woodchipper blades when an operator's arm, leg or other body part is in too close proximity to the mouth of the woodchipper. It would therefore be desirable to have a woodchipper that would automatically shut down the woodchipper blades when an operator's limb or appendage passes in close proximity to the mouth of the woodchipper.

As will become evident in this disclosure, the present invention provides benefits over the existing art.

### BRIEF DESCRIPTION OF THE DRAWINGS

The illustrative embodiments of the present invention are shown in the following drawings which form a part of the specification:

FIG. 1 is a perspective view of a commercial woodchipper presenting a first embodiment of the present invention;

FIG. 2 is a cross-sectional plan view of the woodchipper of FIG. 1;

FIG. 3 is a partial schematic of the commercial woodchipper of FIG. 1, showing a representative human appendage in proximity to the mouth of the woodchipper of FIG. 1, the safety sensors in the mouth, and a schematic representation of the interaction between the safety sensors and the safety stop/brake components of the woodchipper; and

FIG. 4 is a component schematic of the electronic controller of the commercial woodchipper of FIG. 1.

Corresponding reference characters indicate corresponding parts throughout the several views of the drawings.

### DETAILED DESCRIPTION

The following detailed description illustrates the claimed invention by way of example and not by way of limitation. This description will enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. Rather, the invention is intended to cover all alternative embodiments and modifications that fall within the spirit and scope of the invention as defined by the claims included herein as well as any equivalents of the disclosed and claimed invention. Hence, the claimed invention is capable of other embodiments and of being practiced or being carried out in various ways. Also, it is to be understood that the phraseology and terminology used herein is for the purpose of description and should not be regarded as limiting.

Turning to the drawings, a first embodiment of the novel wood automatic safety woodchipper is shown generally at 10 in FIGS. 1-2 where the present invention is depicted by way of example. Of course, the present invention can be embodied in other woodchipper configurations, such as for example any variety of conventional woodchippers that are modified and adapted with the features of the present invention.

Referring to FIGS. 1-2, it can be seen that the woodchipper 10, incorporating one embodiment of this present novel disclosure, includes a generally cubic-shaped rigid metal body 12 having an upper portion 14, a lower portion 16 opposite the upper portion 14, and a front end 18 positioned between the upper portion 14 and the lower portion 16. A pair of wheels 20 are joined to each end of a central supporting axle 22. The axle 22 spans across and is held in place to the underside of the lower portion 16 of the body 12.

A rigid, hollow and elongate metal feed chute 24 is attached to and extends generally horizontally away from the front end 18 of the body 12. The feed chute 24 has an open throat 26 at one end and an open mouth 28 at the opposite end. The feed chute 24 has a generally rectangular cross-section along its full length, but the feed chute 24 expands in height and width as it extends forward away from the body 12 such that the mouth 28 is approximately twice the height and twice the width of the throat 26. The throat 26 mates with a correspondingly shaped opening or feed port 30 in the front end 18 of the body 12. A bucket or trough 32 is hingedly attached to, and extends away from, the bottom lip of the mouth 28, such that the trough 32 can be folded up against the mouth 28 to close access to the feed chute 24.

An internal combustion engine 34 and a set of horizontally rotatable woodchipper blades 36 are both positioned inside the body 12. The engine 34 is attached to and drives the rotation of the blades 36 about a horizontal shaft 37 to shred or chip material fed to and/or pressed against the blades 36, and receives fuel from a fuel tank 39 attached to the body 12. The blades 36 are positioned in a central chamber 38 near the feed port 30 in the front end 18 of the body 12. A discharge port 40 in top of the central chamber 38 provides an opening into the body 12 for a rigid, hollow elongate metal discharge chute 42. The discharge chute 42 extends from a lower end 44 positioned above and proximate the blades 36, upward through the port 40, and away from the body 12 approximately ten feet to a discharge end 46. The discharge end 46 can be rotated horizontally about a pivot bracket 48 just above the body 12. The discharge chute 42 thereby provides a directionally-controlled discharge of shredded material at a distance from the woodchipper 10. The blades 36 are positioned and oriented between the feed port 30 and the discharge chute 42, such that any limbs, brush or other items that are placed in the feed chute 24 must pass through the feed port 30, through the blades 36, and into the discharge chute 42, before being expelled from the woodchipper 10 through the discharge chute 42. A horizontal feed wheel 49, which is powered by the engine 34, is positioned in the bottom of the feed chute 24. The feed wheel 49 provides assistance in moving feed material through the feed chute 24 and into the blades 36.

An electronic control system 50 is contained in a housing 51 that is attached to the outside of the body 12 on the upper portion 14. Referring to FIG. 4, it can be seen that the control system 50 includes a wireless receiver 52, a microprocessor unit 54, a battery circuit 56, a solar panel 58, and a relay 60 that is operatively controlled by the microprocessor unit 54.

The solar panel 58 is not a required component of the control system 50. However, when present, as here in the representative embodiment 10, the solar panel 58 can provide electric current directly to the microprocessor 54 or to the battery circuit 56 to help keep the battery circuit 56 adequately charged.

Similarly, the battery circuit 56 is not a required component of the control system 50, where for example, the control system 50 has some other source of power such as for example where the control system is adapted to run on AC current and can be plugged into a nearby power outlet. However, when present, as here in the representative embodiment 10, the battery circuit 56 enables the operation of the control system on battery power without an external power source. This can be important in that often commercial woodchippers are used in areas that lack a ready source of electricity.

The relay 60 is wired to a kill switch 62 mounted on the engine 34. The microprocessor unit 54 is configured to controllably generate an electronic signal that triggers the relay 60, which in turn toggles or triggers the kill switch 62. The kill switch 62 is interconnected with the engine's ignition system and adapted to halt the operation of the engine 34 when the kill switch 62 is triggered by the relay 60. Moreover, the interface between the kill switch 62 and the engine 34 is such that if the engine 34 is in operation when the kill switch 62 is triggered by the relay 60, the engine 34 will promptly shut down. Further, so long as the kill switch 62 remains so “triggered”, the engine 34 will be unable to operate.

The interface between the kill switch 62 and the engine 34 can be arranged in a variety of ways, depending on the type and configuration of the engine 34, the type of kill switch 62, and the type and configuration of the ignition system for the engine 34. For example, a simple electrical switch can be connected to the wiring for the spark plugs in the engine 34, such that the kill switch 62 separates the spark plugs from the ignition system when the kill switch 62 is triggered by the relay 60. In another example, where the ignition system is an electronic ignition or otherwise operated by a microprocessor, the kill switch 62 can be an integral component of the electronic ignition system that can shut down the operation of the engine 34.

In yet another example, where the woodchipper 10 alternately comprises an electric motor instead of the combustion engine 34, the kill switch 62 merely needs to disrupt the supply of electricity to the electric engine to cease operation of the woodchipper 10. Alternatively, the woodchipper 10 can comprise a brake or braking system for the blades 36 or the shaft 37 that is activated by the kill switch 62 such that when the microprocessor generates an electric signal to stop the woodchipper operation, the kill switch 62 will trigger the brake or braking system to promptly stop the rotation of the blades 36. Similarly, the woodchipper 10 can comprise an external drive in place of the engine 34 to rotate the blades 36.

The woodchipper 10 also has a set of sensor strips 70 attached to the inner surface of the mouth 28. Each of the sensor strips 70 is approximately an inch wide and runs substantially the full length of one side of the mouth 28. Each sensor strip 70 is connected by an electrical wire to the control system 50 such that the sensor strip 70 can obtain electrical power from and communicate an electrical signal to the control system 50.

Alternatively, the sensor strips 70 can be provided with power from a local battery, solar panel or other such device. Further alternatively, the sensor strips 70 can each comprise or can collectively comprise a wireless transmitter that is operatively associated with the wireless receiver in the control system 50, so as to be able to wirelessly communicate the electrical signal to the control system 50.

The woodchipper 10 further includes a wireless signal device 72 that wirelessly communicates with the sensor strips 70. The signal device 72 and the sensor strips 70 are configured such that the sensor strips 70 generate a triggering electronic signal indicative of the presence of the signal device 72 within a preset distance of one or more of the sensor strips 70. Further, the sensor strips 70 and signal device 72 are selected to have an inter-relational sensitivity such that the signal device 72 cannot pass through any portion of the mouth 28 without generating the triggering electronic signal. Such signal device and sensor products are commercially available in a wide variety of shapes, sizes, and operating parameters.

For example, what are known as “Hall Effect Sensors” comprise a sensor that detects and measures magnetic fields proximate the sensor. Typically, such a device's output voltage is directly or relationally proportional to the magnitude of the magnetic field strength passing through the sensor. Thus, the sensor 70 could, for example, in one configuration comprise a Hall Effect Sensor while the signal device 72 would be a particularly specified magnet chosen to generate a magnetic field detectible by the sensor 70 within the range required to safely and timely shut down the woodchipper 10. A wide variety of Hall Effect Sensors and detecting systems are commercially available. See, e.g., https://www.google.com/search?q=halls+effect+sensor&rlz=1C1GCEU_enUS911US911&source=lnms&tbm=shop&sa=X&ved=2ahUKEwi2_ezKm57rAhXGZsOK HXwOB8oQ_AUoAXoECA4QAw&biw=1280&bih=578). Other proximity sensor-signal device proximity detection combinations (e.g. sonic (or ultrasonic), inductive, optical, or capacitive) are likewise commercially available and can readily be chosen as alternatives by one of ordinary skill in the art to accommodate various engineering or design considerations. For example, in areas of operation for the woodchipper 10 where other high magnetic fields are known to exist, a sonic sensor may be used in which the sensor is tuned to detect a sound not detectable by human ears and not generated by the woodchipper 10.

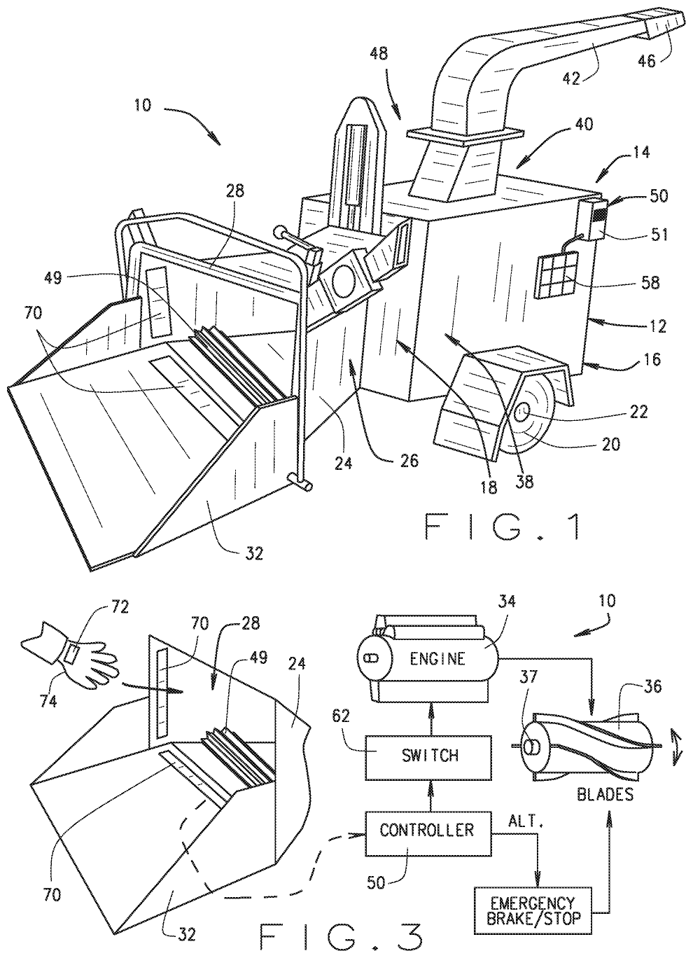

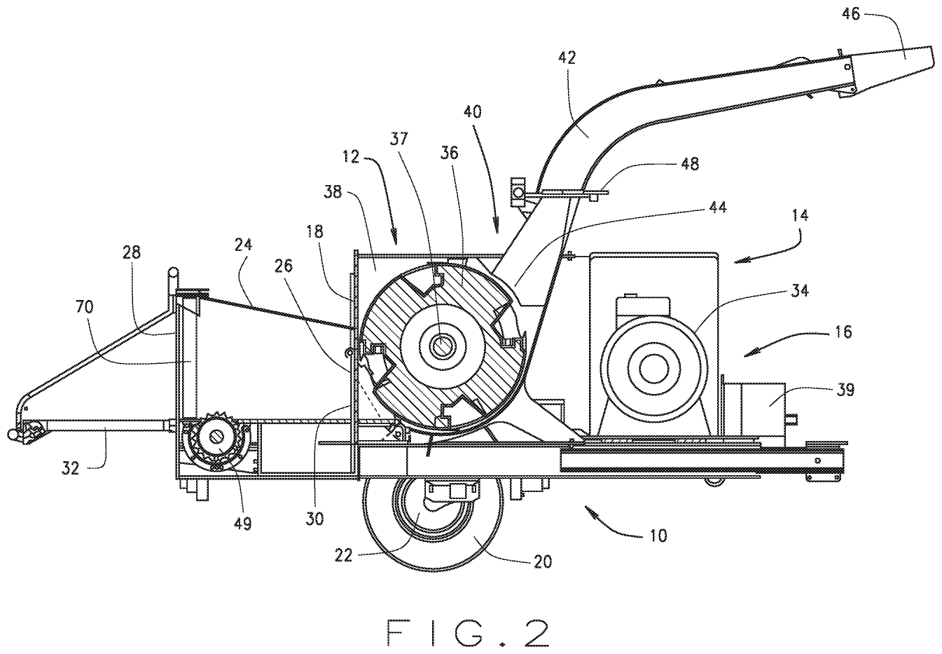

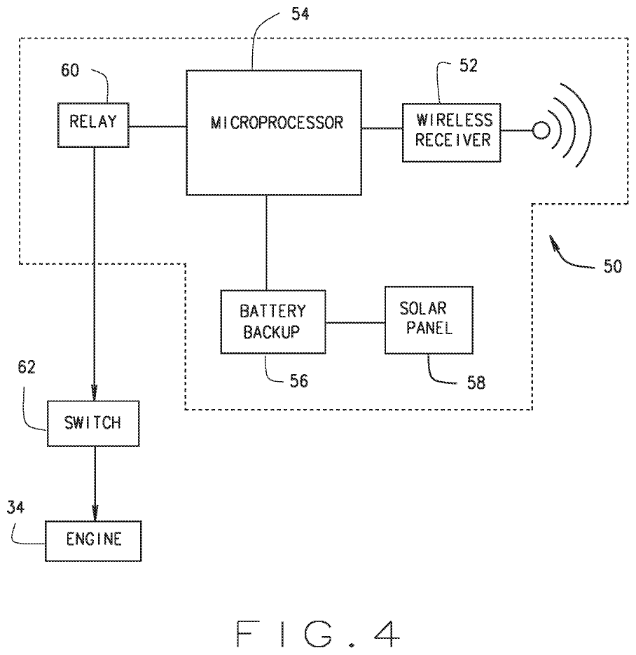

The signal device 72 may be incorporated into safety clothing to be worn by a person operating the woodchipper 10, such as for example, a safety glove 74. Thus, when the woodchipper 10 is in operation, with the engine 34 running to rotate the blades 36, the operator can don the safety glove 74 in or on which the signal device 72 is incorporate. Should the operator's hand, which is covered by the safety glove 74, pass too close to the mouth 28, the signal device 72 in the operator's safety glove 74 will be detected by one or more of the sensor strips 70. The sensor strips 70 will then transmit the triggering electronic signal to the control system 50, either by wireless or hardwire communication. The microprocessor unit 54 will receive the triggering electronic signal from the strips 70 and instruct the relay 60 to trigger the kill switch 62 to immediately shut-down or “kill” the engine 34 and halt the rotation of the blades 36. This “shut down” control path is depicted in FIG. 3. In order to prevent an accidental re-start of the woodchipper 10 following such an emergency shut-down or “kill”, the microprocessor unit 54 can be programmed to prevent the engine 34 from re-starting or otherwise operating again without a manual reset of the control system 50 or the entry of specific user commands.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel woodchipper of the present invention can be arranged in a number of other and related varieties of configurations without departing from or expanding beyond the scope of my invention as set forth in the claims.

For example, instead of the kill switch 62 being operatively associated with the engine 34, the kill switch 62 may alternately be adapted to disengage the engine 34 from the blades 36. By way of further example, the kill switch 62 may be adapted to engage a brake that slows or halts the rotation of the blades 36, as explained above.

By way of yet another example, the signal device 72 may alternately be constructed as an item to be worn by a person operating the woodchipper 10, such as for example, a bracelet or a ring. Further, the signal device 72 can be configured to send the wireless signal to the control system 50 instead of, or in addition to, the sensor strips 70.

In addition, various woodchippers (not shown) are constructed with mechanical and/or automated feed systems that automatically direct or urge the wood logs and/or brush into the woodchipper blades, such as the blades 36. Such mechanical and/or automated feed systems may include, for example, automated conveyor belts, hydraulic thrust rods, rollers, and other such mechanical devices, such as the feed wheel 49 of the woodchipper 10. It is contemplated that where the woodchipper 10 incorporates any one or more of such mechanical and/or automated feed systems, the automated shutoff feature of the woodchipper 10, can be configured to automatically, sequentially and/or simultaneously shutoff the one or more incorporated mechanical and/or automated feed systems associated with the woodchipper 10.

That is, where the woodchipper 10 incorporates one or more mechanical and/or automated feed systems, the relay 60 can additionally be operatively associated with one or more kill switches for each of the one or more mechanical and/or automated feed systems associated with the woodchipper 10. The microprocessor unit 54 can then controllably generate an electronic signal that triggers the relay 60, which in turn toggles or triggers the kill switch 62 and the additional kill switches for the mechanical and/or automated feed systems associated with the woodchipper 10 to shut off all such systems. Thus, when this configuration of woodchipper is operating, should the signal device 72 be detected by one or more of the sensor strips 70. The sensor strips 70 will then transmit the triggering electronic signal to the control system 50. The microprocessor unit 54 will receive the triggering electronic signal from the wireless receiver 52 and instruct the relay 60 to trigger the kill switch 62 to immediately shut-down or “kill” the engine 34 and halt the rotation of the blades 36, while also sending a signal to each of the additional kill switches to shut-down or “kill” the one or more incorporated mechanical and/or automated feed systems associated with the woodchipper 10.

It is also contemplated that upgrade or retrofit kits for woodchippers without the present safety device are encompassed within the art of this disclosure and comprise alternate embodiments of the invention herein. For example, such a retrofit kit may include the control system 50, the switch 62, one or more of the sensors 70 and one or more of the signal devices 72. In which case, each of these components will be adapted for attachment to a woodchipper and integration with the engine or motor of the woodchipper.

Moreover, although the embodiment of woodchipper 10 comprises a microprocessor 54 that operates the automatic blade shutoff, it is contemplated that an alternate embodiment of the present invention may comprise a less sophisticated electronic control system in place of the control system 50. For example, such an alternate control system could comprise a simple electronic signal detector that triggers a switch, such as the switch 62, when an electronic signal is sent to the controller from the sensors 70. Engineering various such alternate embodiments of a controller for the automatic shutoff descried herein, that perform the same function as the controller 50, would be within the capability of one of ordinary skill in the art.

It should also be noted that while the blades 36 must move in order to operate and chip or shred the materials fed into the woodchipper 10, the blades need not rotate, but can alternatively be driven to move in other modes, such as for example, the blades 36 can be configured to oscillate, vibrate or directionally shear.

Additional variations or modifications to the configuration of the novel woodchipper of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. An automatic shutoff woodchipper, said woodchipper comprising:
a. a body having a central chamber;
b. a blade for shredding material fed into the woodchipper proximate said blade, said blade being positioned in the central chamber and adapted to move in a controlled manner within said central chamber to facilitate said shredding;
c. a motor, said motor being operatively attached to the blade and driving said blade to move in said controlled manner;
d. an electronic controller adapted to generate an electronic shutoff signal;
e. an electronic switch operatively associated with the blade and in communication with the electronic controller to receive the electronic shutoff signal from the electronic controller, said electronic switch halting the operation of the blade upon receiving the electronic shutoff signal;
f. a feed chute having a mouth and a throat opposite the mouth, said throat opening into the central chamber proximate the blade;
g. an electronic sensor positioned proximate the mouth and being in communication with the electronic controller to communicate to the electronic controller an electronic proximity signal, the electronic controller generating said electronic shutoff signal upon receiving the electronic proximity signal from the electronic sensor; and
h. a signal device in wireless communication with the electronic sensor, said electronic sensor and signal device generating said electronic proximity signal when the signal device is positioned within a predetermined distance from the electronic sensor.

2. The automatic shutoff woodchipper of claim 1, wherein the motor is one of an internal combustion engine, an electric motor, and an external drive.

3. The automatic shutoff woodchipper of claim 1, wherein the signal device is adapted to be worn by an operator.

4. The automatic shutoff woodchipper of claim 1, wherein the electronic switch is operatively associated with the motor and in communication with the electronic controller to receive the electronic shutoff signal from the electronic controller, said electronic switch halting the operation of the motor upon receiving the electronic shutoff signal.

5. The automatic shutoff woodchipper of claim 1, wherein the signal device comprises one of (i) a magnet; and (iii) an RFID circuit that wirelessly generates the proximity signal and transmits said proximity signal to the electronic sensor.

6. The automatic shutoff woodchipper of claim 1, wherein the electronic sensor wirelessly communicates the electronic shutoff signal to the electronic controller.

7. The automatic shutoff woodchipper of claim 1, wherein the electronic sensor comprises one of a magnetic, sonic, ultrasonic, inductive, optical, or capacitive proximity sensor.

8. The automatic shutoff woodchipper of claim 1, wherein the electronic control system comprises a microprocessor, said microprocessor being in communication with said electronic sensor and said electronic switch, said microprocessor being programmed to trigger said electronic switch to shut off the motor when the electronic sensor communicates said electronic proximity signal to the microprocessor.

9. The automatic shutoff woodchipper of claim 1, wherein the electronic control system comprises one of a battery backup circuit, a solar panel and a wireless receiver, said battery backup circuit providing electric current to operate the electronic control system, said solar panel providing electric current to operate the electronic control system, said wireless receiver being adapted to wirelessly receive the electronic proximity signal from a wireless electronic sensor.

10. The automatic shutoff woodchipper of claim 1, wherein the electronic control system comprises a relay, the electronic controller operating the relay to trigger the switch to shut off the motor when the electronic control system receiving the electronic proximity signal.

11. The automatic shutoff woodchipper of claim 1, wherein the blade moves at least in part by one of said acts of oscillation, rotation, vibration and directional shearing.

12. The automatic shutoff woodchipper of claim 1, further comprising two or more blades, each of said two or more blades being positioned in the central chamber and adapted to move in a controlled manner within said central chamber to facilitate said shredding.

13. The automatic shutoff woodchipper of claim 1, further comprising a brake, said brake being adapted to halt the operation of the blade, said brake being operatively associated with said electronic control system to halt the operation of the blade upon receiving the electronic shutoff signal from the electronic controller.

14. An automatic shutoff system for a woodchipper, the woodchipper having a blade for shredding material fed into the woodchipper proximate said blade, a motor operatively attached to the blade to drive said blade to move in said controlled manner, a feed chute having a mouth for the placement of material to feed into said woodchipper for shredding by the blade, said automatic shutoff system comprising:
a. an electronic controller adapted to generate an electronic shutoff signal;
b. an electronic switch operatively associated with the blade and in communication with the electronic controller to receive the electronic shutoff signal from the electronic controller, said electronic switch halting the operation of the blade upon receiving the electronic shutoff signal;
c. an electronic sensor positioned proximate the mouth and being in communication with the electronic controller to communicate to the electronic controller an electronic proximity signal, the electronic controller generating said electronic shutoff signal upon receiving the electronic proximity signal from the electronic sensor; and
d. a signal device in wireless communication with the electronic sensor, said electronic sensor and signal device generating said electronic proximity signal when the signal device is positioned within a predetermined distance from the electronic sensor.

15. The automatic shutoff system of claim 14, further comprising a brake, said brake being adapted to halt the operation of the blade, said brake being operatively associated with said electronic control system to halt the operation of the blade upon receiving the electronic shutoff signal from the electronic controller.

16. The automatic shutoff wood system of claim 14, wherein the signal device is adapted to be worn by an operator.

17. The automatic shutoff system of claim 14, wherein the signal device comprises one of (i) a magnet; and (iii) an RFID circuit that wirelessly generates the proximity signal and transmits said proximity signal to the electronic sensor.

18. The automatic shutoff system of claim 14, wherein the electronic sensor wirelessly communicates the electronic shutoff signal to the electronic controller.

19. The automatic shutoff system of claim 14, wherein the electronic control system comprises a microprocessor, said microprocessor being in communication with said electronic sensor and said electronic switch, said microprocessor being programmed to trigger said electronic switch to shut off the motor when the electronic sensor communicates said electronic proximity signal to the microprocessor.

20. The automatic shutoff system of claim 14, wherein the woodchipper further comprises a brake that halts the operation of the blade, and said electronic switch is adapted to engage said brake, and said electronic control system triggers said electronic switch to engage the brake to halt the operation of the blade when the electronic sensor communicates said electronic proximity signal to the electronic controller.
